(19) United States
(12) Patent Application Publication
(10) Pub. No.: US 2017/0124643 A1
(43) Pub. Date: May 4, 2017

(54) RECYCLING SYSTEM

(71) Applicants: Shlomo Uri HAIMI, Or Akiva (IL); Ziv OHANA, Zichron Yakov (IL)

(72) Inventors: Shlomo Uri HAIMI, Or Akiva (IL); Ziv OHANA, Zichron Yakov (IL)

(21) Appl. No.: 15/319,788

(22) PCT Filed: Jun. 18, 2015
(86) PCT No.: PCT/IL2015/050620

§ 371 Date: Dec. 18, 2016

Related U.S. Application Data
(60) Provisional application No. 62/014,162, filed on Jun. 19, 2014.

(51) Int. Cl. G06Q 40/02; H04L 29/08; G06K 19/06

(52) U.S. Cl. CPC G06Q 40/02; G06K 19/06009; H04L 67/18; G06Q 50/26

(57) ABSTRACT

A method, system and computer program product for directly reimbursing an individual that recycles an item that is marked according to the system of the immediate invention, the system including: a computer, including a processor and memory, the memory having stored thereon: a unique code database including at least one unique code, the unique code corresponding to a recyclable article: and a remuneration engine configured to associate the recyclable article with a value; a scan-able, printed, unique indicia operationally coupled to the recyclable article, the printed, unique indicia corresponding to the unique code related to the recyclable article; such that when the printed, unique indicia is scanned by a device, the remuneration engine credits a user account be longing to the device with the value; and updates the unique code database to indicate that the printed, unique indicia has been scanned, thereby preventing subsequent remuneration for scanning the printed, unique indicia.

This patent application claims priority from and benefit of U.S. Provisional Patent Application No. 621014,162, filed Jun. 19, 2014, which is incorporated in its entirety as if fully set forth herein.

### FIELD OF THE INVENTION

The present invention relates to a method, system and computer program to increase recycling of packaging and, more particularly, to a method and system for directly reimbursing individuals that recycle.

### BACKGROUND

Various attempts have been made to provide incentives to individuals for recycling various types of containers. In some regions cans and bottles now carry a surcharge for the bottles and cans which can be redeemed when the container has been recycled. The consumer often has the option of taking the containers to a recycling center or to as recycling machine or back to the vendor (or an similar vendor, for that matter). At any of these locations the consumer is reimbursed for the containers returned. In some situations the consumer is given money in return for the recycled goods. In other situations the consumer receives a token which in turn can be redeemed by some vendor (e.g. recycling machines located in Walmart® stores award a ticket for each recycled item; the tickets can then be used as payment vouchers in the store).

### SUMMARY OF THE INVENTION

According to the present invention there is provided a method, system and computer program product for directly reimbursing an individual that recycles an item that is marked according to the system of the immediate invention. Preferably the consumer is reimbursed directly to their bank account, or other comparable account such as a credit card or debit card account. In one embodiment, the consumer sets up an account with the system of the immediate invention. The system account may or may not be linked to one of the aforementioned accounts.

Preferably the method, system and computer program product are tamper-proof, thereby protecting the individual from theft and the product for being tampered with. In one embodiment, the product is a computer program product which can be implemented on a hand-held or mobile computing device. In this manner, existing recycling bins, cages, depots, receptacles etc., can be upgraded technologically to be included in the system quickly, easily and with almost no cost. All the recycling bin needs is a barcode or some other indicia that is referenced in the system database according to type of recyclable, size of the receptacle and geographic location.

According to the present invention there is provided a direct remuneration system for recycled articles, the system including: (a) a computer, including a processor and memory, the memory having stored thereon, at least: (i) a unique code database including at least one unique code, the unique code corresponding to a recyclable article; and (ii) a remuneration engine configured to associate the recyclable article with a value; (b) a scan-able, printed, unique indicia operationally coupled to the recyclable article, the printed, unique indicia corresponding to the unique code related to the recyclable article; such that when the printed, unique indicia is scanned by a device, the remuneration engine credits a user account belonging to the device with the value; and updates the unique code database to indicate that the printed, unique indicia has been scanned, thereby preventing subsequent remuneration for scanning the printed, unique indicia.

According to further features in preferred embodiments of the invention described below the memory further includes; (ii) a recycling receptacle tracker module, the tracker module including a plurality of unique identifiers, each of the unique identifiers corresponding to a respective data entry, stored in the memory, detailing location coordinates corresponding to a physical location of a respective recycling receptacle.

According to still further features in the described preferred embodiments the system further includes at least one unique indicia operationally coupled to a respective recycling receptacle, the unique indicia related to a corresponding unique identifier, in the tracker module, such that when the computer receives an electronic indication of the unique indicia, from the device, the processor cross-checks a location of the device with the location coordinates of the recycling receptacle, stored in the memory, so as to only allow the remuneration engine to credit the user account if the location of the device coincides with the location coordinates of the recycling receptacle.

According to still further features the system further includes a web interface configured to facilitate access to the user account and management thereof.

According to still further features the system further includes computer readable instructions adapted to be installed on a mobile computing device, the mobile computing device including a scanning apparatus adapted to scan the scan-able indicia, wherein the computer-readable instructions adapted to: control function of the scanning apparatus, communicating with the computer, and facilitating management of the user accounts.

According to another embodiment there is provided a computer-implemented method for directly remunerating a user for recycling, the method including: (a)) providing a unique indicia for a recyclable item that, when scanned, maps back to a network address corresponding to computer, the computer comprising a processor and memory, the memory having a database stored thereon including a data entry corresponding to the unique indicia; (b) receiving, at the network address, an electronic indication that the unique indicia has been scanned; (e) receiving a user ID related to a device that scanned the unique indicia; (d) associating the recyclable item with a value and crediting a user account belonging to the user ID with the value; and (e) updating the database to indicate that the unique indicia has been scanned, thereby preventing subsequent remuneration for scanning the unique indicia.

According to further features the method further includes the step of: (f) prompting the device to provide an identifier corresponding to a recycling receptacle to which the recyclable item is inserted.

According to still further features the method further includes the step of: (g) receiving the identifier and updating a corresponding data entry, in the memory, to indicate that the recyclable item is currently housed in the recycling receptacle.

According to still further features the method further includes the step of (h) receiving location information of the device and cross-checking the location information of the device with location information relating to the recycling receptacle, stored in the memory, so as to only allow crediting if a location of the device coincides with a location of the recycling receptacle.

According to still further features the method further includes the step of (h) calculating an estimated capacity level of the recycling receptacle based on a number of recyclable items housed therein.

According to another embodiment there is provided a system including: at least one processor; at least one non-transitory computer readable medium storing a database including a data entry corresponding to a unique indicia for a recyclable item, the non-transitory computer readable medium storing instructions executable by the system, using the at least one processor to implement computer code for receiving, at the processor, an electronic indication that the unique indicia has been scanned; computer code for receiving, at the processor, a user ID related to a device that scanned the unique indicia; computer rode for associating the recyclable item with a value and crediting a user account belonging to the user ID with the value; and computer code for updating the database to indicate that the unique indicia has been scanned, thereby preventing subsequent remuneration for scanning the unique indicia.

### BRIEF DESCRIPTION OF THE DRAWINGS

Various embodiments are herein described by way of example only with reference to the accompanying drawings, wherein:

FIG. 1 is a flow diagram reflecting one embodiment of the process of the immediate invention:

FIG. 2 is a flow diagram reflecting another embodiment of the process of the immediate invention;

FIG. 3 is a block diagram of the innovative system;

FIG. 4 is a block diagram of the memory.

### DESCRIPTION OF THE PREFERRED EMBODIMENTS

Some of the terms used herein may be seen as ambiguous and therefore confusing. Some of these terms are explained and expanded here, to ensure clarity. The explanations are not intended for the purpose of limiting the terms in any way but rather to simply clarify their meaning.

“Recyclable packages”, “recyclable items”, “recyclable articles” and variations thereof refer to bottles, soda cans, condiment cans, plastic containers (food, detergents, milk, ice cream etc.) and the like that can be recycled, and for which recycling receptacles exit. As referred to herein, the recyclable items are also reimbursable items, i.e. the owner is remunerated for recycling the item.

“Unique identifier”, “optically scan-able, unique indicia”, “printed indicia”, “unique indicia” and variations thereof refer to a unique code printed on, or belonging to, a recyclable item or recycling receptacle. Each article is identified by a unique indicium, such as a barcode. Of course other methods of identification may be used such as QR codes, NFC tags, RFID tags and the like. The word ‘barcode’ is used throughout the documents but is clarified to also mean other types of scan-able, photograph-able or otherwise detectable identification means.

“Reimbursement”, “remuneration” and variations thereof, refer to some manner of financial or other remuneration.

“Scan”, “scanning”, “scan-able” and variations thereof, refer to the function of optically scanning or capturing an image which is processed to interpret printed indicia (e.g. barcodes, OR codes etc.). Scanning can also refer to the function of electronically ‘reading’ an electronic tag such as a Near Field Communication (NFC) tag, a Radio Frequency Identification (RFID) tag, a Bluetooth beacon and the like, in order to capture the information stored in, or represented by, the indicia (which includes all, of the aforementioned printed and electronic media).

The principles and operation of a reimbursement method and system according to the present invention may be better understood with reference to the drawings and the accompanying description.

In preferred embodiments of the system, each recyclable article receives a unique serial number, barcode, OR code or some similar unique indicia. Preferably the indicia are printed, optically scan-able indicia such as a barcode, a QR code, a NFC tag, an RPM tag and the like.

The indicia may be printed on the label of the recyclable article, or directly on the article itself. The logo, nutritional information, ingredients and barcode are printed directly on aluminum cans such as soda and beer cans, whereas beer bottles and the like have all that information printed on a label which is glues onto the bottle. In the present system and method, an additional indicium—the scan-able unique indicia—is added to the other printed material on the recyclable article. The indicia is unique to the specific item.

Preferably each manufacturer creates scan-able indicia that include in the code an identification of the recyclable material, the type of article and the manufacturer. For example, a barcode can include a factory code and a material code which from the first digits of the barcode, with the remaining digits being unique serial numbers for each individual item.

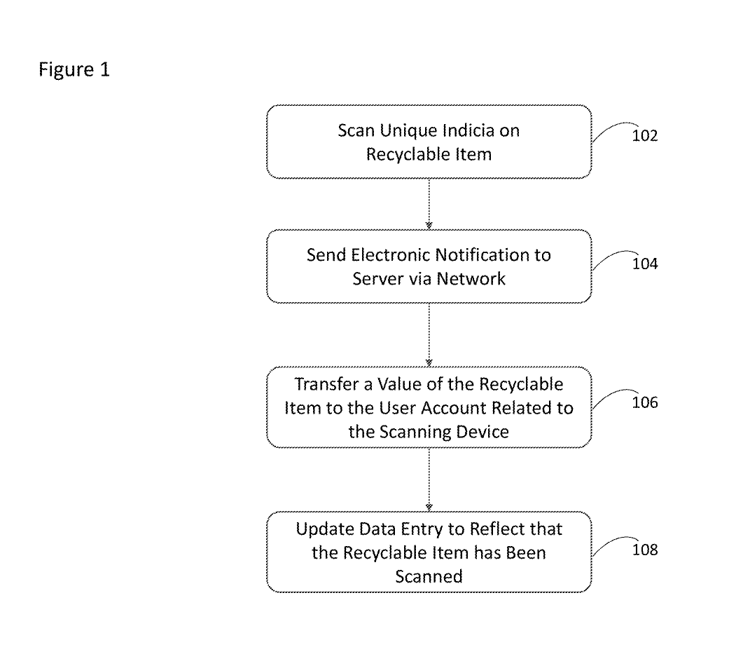

Referring now to the drawings. FIG. 1 illustrates a flow diagram reflecting one embodiment of the process of the immediate invention.

Step 102—In the first step of the process a user scans the unique code of a recyclable article. Preferably, the unique code is a printed, scan-able indicium/indicia that can be scanned by a handheld device. For example, a smart phone includes a camera that is activated by a software application that is installed on the phone. For example, the software application can be a scanning application that uses the camera to scan or read a barcode or QR code. Alternatively the indicium can be an RFID tag, an NFC tag or any other similar technology that is scan-able by the smart phone.

Step 104—Once the code is scanned, the application on the handheld sends an electronic notification to the system server, over a communications network, notifying the system that the specific item has been scanned. In preferred embodiments, the code/indicium maps back to a data record or entry in an Article/Unique Indicia Database stored in the server memory.

Step 106—When the server receives the notification, the system additionally receives a user ID of the scanning device that scanned the code. The user ID is related to a user account. The system associates the recyclable item with a value and credits the user account belonging to user ID with that value. The value may be a monetary value, a coupon, a discount or any other form of remuneration.

The following is an exemplary list of potential ways in which the user account can be credited for recycling: (a) a check can be sent to the recycler or a bank transfer (the user can see on the website what has been recycled and how much he has in credit); (b) a coupon or store credit from the manufacturer or the store that sold the item; (c) the credit can used in a recycling competition, e.g. between cities, schools, districts etc.

Step 108—Once the user account has been credited, the data entry/record is updated to reflect the fact that the item has been scanned. In this manner, the specific recyclable item is ‘removed’ from the database of redeemable items, to prevent ‘double recycling’. For example, one database includes all the unredeemed article codes and another database includes all the redeemed codes (the databases are mutually exclusive), once a barcode has been scanned the code entry/record moves from the ‘unredeemed’ database to the ‘redeemed’ database.

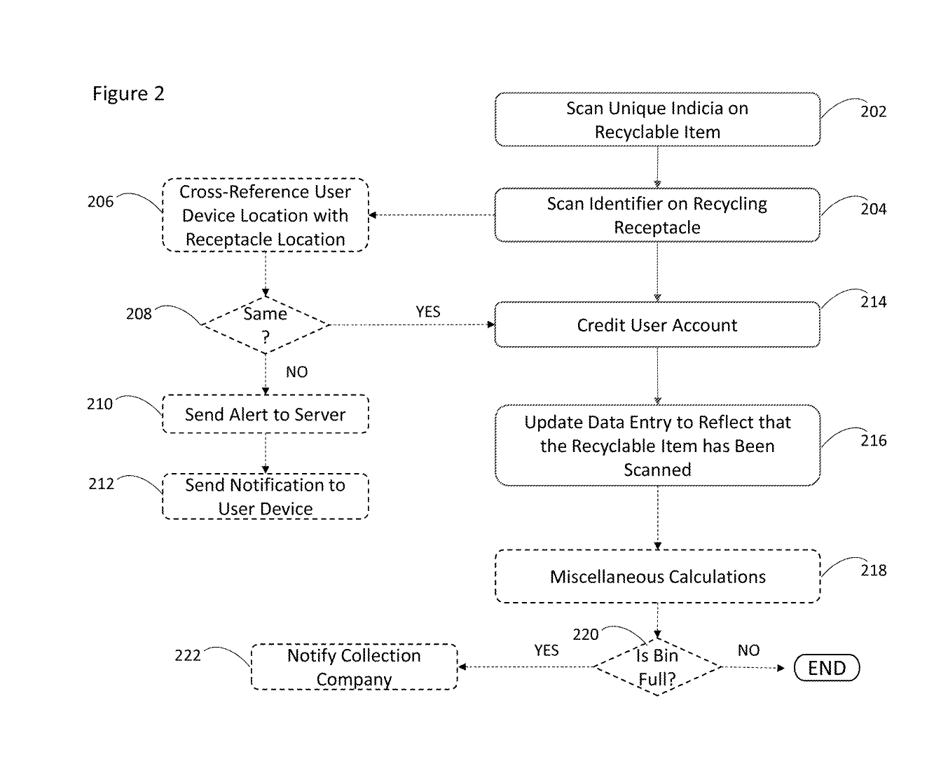

Another possible configuration of the system and process is shown in FIG. 2. In the embodiment detailed in FIG. 2, each recycling bin or receptacle is also marked with a unique code, The code can be a serial number, a scan-able code such as a barcode or QR code, or any other indicia providing the receptacle with a unique designation. Exemplarily, the barcode or QR code can be coded according to type of recyclable material (bottles, soda cans, etc.) the receptacle is designed to receive as well as the geographical location of the bin.

Preferably the indicia maps back to a data entry or record in a database (referred to elsewhere as a Receptacle Tracker Module) of the system server. In one preferred embodiment, the indicia is a QR code that, when scanned, sends an electronic indication over the communications network to the server computer where the data entry or record corresponding to that recycling receptacle is updated, to indicate that the scanned recyclable item is now housed in that recycling receptacle. As mentioned, the data record further contains details about the receptacle such as the location of the receptacle, the type of recyclables it is designed to house and the size.

FIG. 2 illustrates a flow diagram reflecting another embodiment of the process of the immediate invention. The order of the following steps is preferred but not intended to be limiting.

Step 202—In the first step of the process a user scans the unique code of a recyclable article, as in FIG. 1.

Step 204—In some embodiments, the software application on the handheld device prompts the user to enter a code corresponding to the recycling receptacle. The code can be any type of indicia, as discussed above.

Step 206—In some embodiments, the system includes optional anti-fraud procedures to prevent users from taking advantage of the system. The optional steps are depicted in with broken lines. In one embodiment, the system receives the location coordinates of the scanning device used to scan the recyclable article. The coordinates of the scanning device are cross referenced with the location coordinates of the recycling bin (the location coordinates and other information regarding the recycling receptacle are stored in the system memory, as discussed above).

Step 208—if the two sets of coordinates coincide, within a predefined deviation, the system is allowed to forward the payment to the user account related to the scanning device (in step 214). If the locations do not coincide then the system assumes that fraudulent activity is taking place and the user account is not remunerated.

Step 210, 212—In one exemplary embodiment, if the coordinates do not coincide, an alert is sent to the system administrator and/or a notification is sent to the scanning device.

Step 214—When the server receives the unique article code and/or the receptacle code, the system additionally receives a user ID of the scanning device that scanned the unique article code. The user ID is related to a user account. The system associates the recyclable item with a value and credits the user account belonging to user ID with that value. The value may be a monetary value, a coupon, a credit, a discount or any other form of remuneration as discussed above with reference to FIG. 1.

Step 216—Once the user account has been credited, the data entry/record is updated to reflect the fact that the item has been scanned. In this manner, the specific recyclable item is ‘removed’ from the database of redeemable items, to prevent ‘double recycling’.

In some embodiments of the invention, the system further includes additional, optional, process steps. As the following steps are optional, they are depicted with broken lines.

Step 218—Various miscellaneous calculations can be made regarding the recycling receptacle and/or recycled items. For example, a statistical analysis of the types of items recycled t e.g. soda cans as opposed to beer cans) as well as any of a large range of other calculations can be performed. In one embodiment, the system further includes a Capacity Engine (not shown) that calculates and/or estimates whether the receptacle is filled to capacity based on the number of scanned items and the respective size of each item. Of course, for some receptacles the calculation cannot be exact for various reasons. For example, some recyclable articles may be inserted into the receptacle without being scanned; some of the scanned articles may not retain their original volume, e.g. glass bottles can break when inserted into the receptacle, resulting in the broken glass taking up less space than an unbroken bottle.

Step 220—The system decides whether the receptacle is nearly full.

Step 222—If the receptacle is estimated to be nearly full, the collection company is notified to send a vehicle/operator to empty the receptacle.

In some embodiments, the system can perform additional or alternative functions. For example, the system can cross reference the recyclable item with the receptacle and, if the two are not compatible, send a notification to the user device alerting the user to the fact that the receptacle is not intended for the type of recyclable article that has been scanned (e.g. if the recycling bin is for glass bottles and the user scans a beer can, the system will alert the user that the receptacle does not accept beer cans). Furthermore, the user will not be credited for the scanned item.

Advertising Incentive

In some embodiments of the system, the server and/or application serve as an advertising platform for manufacturers that participate in the immediate system. For example, the system administrators can provide an incentive for manufacturers to is print the unique scan-able indicia for the recyclable articles in the form of advertising space on the mobile application or website.

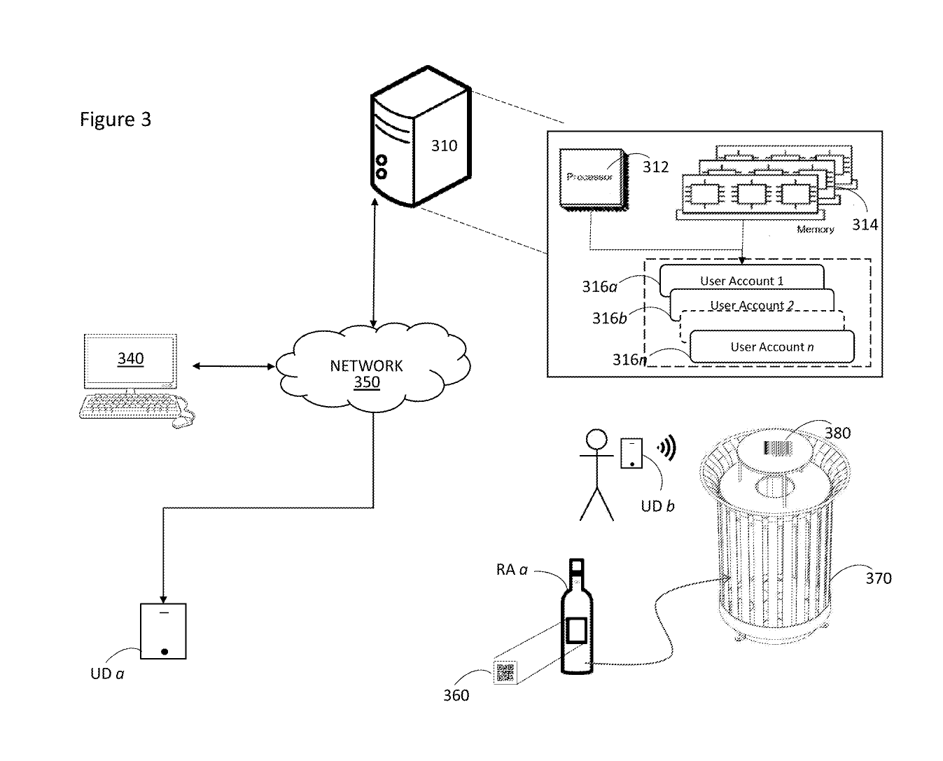

FIG. 3 illustrates a block diagram of the innovative system 300. System 300 includes one or more server(s) are provided remotely and accessible via a network 350, such as the Internet, the Public Switch Telephone Network (PSTN), a cellular network, or others known to those skilled in the art. For example, a series of servers corresponding to a web server, an application server, and a database server may be used. These servers are all represented by server 310. The server is in communication with client side user devices UDa . . . UDn over communications network 350. User devices UD a . . . n are mobile devices, such as a telephone, a computer (laptop, tablet, handheld), a personal digital assistant (PDA), a smart phone and the like, each of which are capable of scanning, or otherwise electronically capturing and transmitting, scan-able indicia.

A recyclable article RA a (depicted in the Figure as a bottle) includes a unique indicium/indicia 360 that is scan-able by the mobile device UDn. Recyclable articles RAn . . . RAn can be collected in a recycling receptacle 370. In some embodiments, the recyclable receptacle is marked with a unique identifier 380. In some embodiments, the Unique identifier can also be scanned by mobile device UDn.

In other embodiments, the server includes or interfaces with a website (not shown). The website serves as a ‘Virtual Recycling Website’ for users to setup and manage personal user accounts. In some embodiments the server 310 hosts the website and/or user accounts. In other embodiments a separate Web Server (not shown) hosts the website and/or the user accounts. Users can interface with the website and user accounts via the communications network from the mobile devices and/or other computing devices, such as PC 340.

The server 310 comprises, amongst other things, a plurality of user accounts 316a . . . 316n managed by a processor 312, the processor being coupled to a memory 314. It should be understood that while the user accounts 316a . . . 316n presented herein are illustrated and described as separate entities, they may be combined or separated in a variety of ways to create groups and sub-groups etc.

One or more databases may be integrated directly into memory 314 or may be provided separately therefrom and remotely from the server 310. In the case of a remote access to the databases, access may occur via any type of network 350, as indicated above. The various databases described herein may be provided as collections of data or information organized for rapid search and retrieval by a computer. They are structured to facilitate storage, retrieval, modification, and deletion of data in conjunction with various data-processing operations. They may consist of a file or sets of files that can be broken down into records, each of which consists of one or more fields or data entries. Database information may be retrieved through queries using keywords and sorting commands, in order to rapidly search, rearrange, group, and select the field. The databases may be any organization of data on a data storage medium, such as one or more servers.

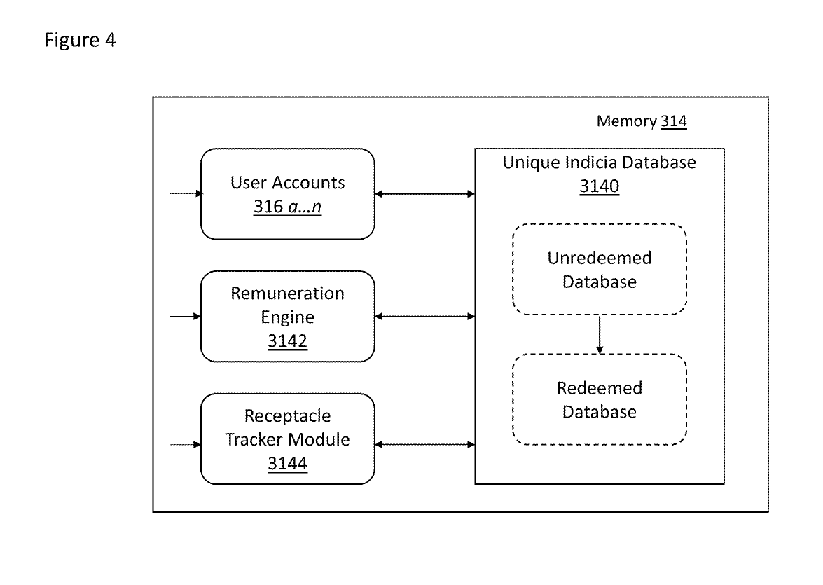

FIG. 4 is a block diagram of memory 314. In one embodiment, Memory 314 includes a unique indicia database 3140 (a barcode or QR code bank) that includes data entries or records relating to each unique indicia in the system. Each data entry or record includes information regarding the recyclable article the unique indicia/indicium relates to. At the very least, the data entry includes an indicator of whether the article has been scanned (redeemed and recycled) or not. In some embodiments, as mentioned above, a separate database exists for redeemed and unredeemed articles. When an article is scanned and reimbursement is provided, the data record is moved from the ‘unredeemed’ database to the ‘redeemed’ database.

Preferably, the data record further includes information relating to any or all of the type of recyclable material (e.g. metal, plastic, glass, etc.), the nature of the article (e.g. bottle, can, etc.), volume of the article, the manufacturer, the location of the receptacle, etc.

In one embodiment, the databases are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). An SSL session may be started by sending a request to the Web server with an HTTPS prefix to in the URL, which causes port number “443” to be placed into the packets. Port “443” is the number assigned to the SSL application on the server. Identity verification of a user may be performed using usernames and passwords for all users. Various levels of access rights may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol) FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol) RFB (Remote Frame buffer) Protocol.

Referring alternatively to both FIGS. 3 and 4, the memory 314 accessible by the processor 312 receives and stores data. The memory 314 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc.

The processor 312 may access the memory 314 to retrieve data. The processor 312 may be any device that can perform operations on data. Examples are a central processing unit (CPU), a front-end processor, a microprocessor, a graphics processing unit (GPU/VPU), a physics processing unit (PPU), a digital signal processor, and a network processor.

In preferred embodiments, a Remuneration Engine 3142 is stored in memory 314 and accessible by processor 312. A mentioned above, remuneration can be in the form of monetary remuneration such as a check that is sent to the recycler or a bank transfer to a bank account or crediting a credit or debit card or other rechargeable card. The remuneration can be store or chain specific, such as a coupon (e.g. an electronic coupon sent to a registered email address) or store credit. In such embodiments, remuneration engine (or similar module) 3142 interfaces with a monetary account such as a bank account, credit card account and the like, via network 350. The engine is configured to directly credit the monetary account as remuneration for recycling the scanned reimbursable, recyclable articles.

Alternatively or additionally, the credit can be in the form of ‘points’ that are earned for a group to which the recycler belongs, e.g. a school, district, company, etc. The points are used in a competition or other arrangement whereby earning points awards or has the potential to win the group some type of prize (financial or otherwise). In such a scenario, remuneration engine 3142 interfaces with user accounts in order to credit the individual or group account.

In embodiments of the invention that include recycling receptacle identifiers, a Receptacle Tracker Module 3144 contains a database of receptacle identifiers and data records relating to the receptacles. As mentioned above, the data records further contain details about each of the receptacles such as the location of the receptacle, the type of recyclables it is designed to house and the size. Statistical information can likewise be included in the records.

Mobile Application

Interfacing with the server (or another server hosting the program), each user downloads a mobile application (app) for a smart phone, tablet etc. The mobile application controls and activates the scanning functions of the device and allows the user to manage the user account. A user can sign up for a user account either via the application or the web interface website (discussed below).

When signing up for a user account, the user provides the necessary personal information, details regarding a preferred avenue of remuneration, and details regarding the user device (UD) the user will use for scanning the recyclable articles. The user device contains a user ID that uniquely identifies the device (e.g. a MAC address). Whenever the user device communicates with the server, the user device provides the user ID in order to identify the user device. The user device is now linked to the user account which is further linked to a remuneration account (whether a ‘points’ account or a monetary account or a variation/combination of both). In some embodiments, the user device also provides the location of the user device (based on location services of the device such as WiFi, GPS, cell tower triangulation and the like).

When a user arrives at a recycling depot/bin, the user scans or inputs the receptacles unique identifier (serial number, barcode, QR code etc.) with a smart phone or other user device. Photographing or otherwise scanning the indicia opens the application (if not already open) and connects the device to the server. The user then o scans the barcode (or ‘recycle-code’ if more than one barcode appears on the container). In some embodiments, the steps are reversed.

As mentioned, the mobile device and recycling bin can be cross checked to make sure that the user is at the recycling bin when registering (scanning) the recycled items. The application can also be used to locate a nearby recycling bin that is part of the system.

As discussed, once an item is recycled the unique code is extracted from the barcode database. The data gathered by the server/system can be used for data mining purposes, segmentation, consumer habits and to provide statistical data. The system can support a dedicated or existing social network, user inter-communication and group-wide notifications.

Web Interface

In some embodiments of the invention, the system further includes a web interface and/or a website (not shown). The web interface may be hosted by sever 310 or a distinct web server, as discussed above. The user can access the user account via web interface/website. The user logs on with credentials such as a username and password. The user can manage the user account with an end-user device such as the handheld UD or some other computer (PC, laptop, tablet, etc.) connected to the server via the network.

In preferred embodiments, all data is available on the system website. The system can support competitions, incentive based programs, environmental programs etc, where the interaction between the individual and/or group and/or system facilitates/supports recycling on an individual and social level.

All methods described herein can be performed on one or more electronic processors and/or computers working with each other. These processors/computers can be in the same or different physical locations connected by any type of computer communications network.

All features of documents that are incorporated by reference can be combined without limitation with each other and with features described in the text fully set forth herein. Features described herein can be combined with any feature(s) in the documents incorporated by reference without limitation.

It is noted that the order of any of the operations described herein can be performed in any order. Any operation described herein can also be optional. All flowcharts herein are not intended to illustrate the only possible implementation, and modifications and deviations can be added which include any feature described herein or based on well-established principles. For example, while endless loops may be theoretically possible in some flowcharts, in reality such situations could be handled using common sense approaches. Any embodiments herein can also be stored in electronic form and programs and/or data for such can be stored on any type of computer readable storage medium (e.g. CD-ROM, DVD, disk, etc.)

The descriptions provided herein also include any hardware and/or software known in the art and needed to implement the operations described herein. All components illustrated herein may also optionally communicate with any other component (either illustrated/described herein or not described but known in the art).

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is

1. A direct remuneration system for recycled articles, the system comprising:
(a) a computer, comprising a processor and memory, said memory having stored thereon, at least:
(i) a unique code database including at least one unique code, said unique code corresponding to a recyclable article; and
(ii) a remuneration engine, configure to associate said recyclable article with a value;
a scan-able, printed, unique indicia operationally coupled to said recyclable article, said printed, unique indicia corresponding to said unique code related to said recyclable article;
such that when said printed, unique indicia is scanned by a device said remuneration engine credits a user account belonging to said device with said value; and updates said unique code database to indicate that said printed, unique indicia has been scanned, thereby preventing subsequent remuneration for scanning said printed, unique indicia.

2. The system of claim 1, herein said memory further includes:
(ii) a recycling receptacle tracker module, said tracker module including a plurality of unique identifiers, each of said unique identifiers corresponding to a respective data entry, stored in said memory, detailing location coordinates corresponding to a physical location of a respective recycling receptacle.

3. The system of claim 2, further comprising:
(c) at least one unique indicia operationally coupled to a respective said recycling receptacle, said unique indicia related to a corresponding said unique identifier, in said tracker module, such that when said computer receives an electronic indication of said unique indicia, from said device, said processor cross-cheeks a location of said device with said location coordinates of said recycling receptacle, stored in said memory, so as to only allow said remuneration engine to credit said user account if said location of said device coincides with said location coordinates of said recycling receptacle.

4. The system of claim 1, further comprising a web interface configured to facilitate access to said user account and management thereof.

5. The system of claim 1, further comprising computer-readable instructions adapted to be installed on a mobile computing device, said mobile computing device including a scanning apparatus adapted to scan said scan-able indicia, wherein said computer-readable instructions adapted to: control function of said scanning apparatus, communicating with said computer, and facilitating management of said user accounts.

6. A computer-implemented method for directly remunerating a user for recycling, the method comprising:
(a) providing a unique indicia for a recyclable item that, when scanned, maps back to a network address corresponding to computer, said computer comprising a processor and memory, said memory having a database stored thereon including a data entry corresponding to said unique indicia;
(b) receiving, at said network address, an electronic indication that said unique indicia has been scanned;
(c) receiving a user ID related to a device that scanned said unique indicia;
(d) associating said recyclable item with a value and crediting a user account belonging to said user ID with said value; and
(e) updating said database to indicate that said unique indicia has been scanned, thereby preventing subsequent remuneration for scanning said unique indicia.

7. The method of claim 6, further comprising the step of:
(f) prompting said device to provide an identifier corresponding to a recycling receptacle to which said recyclable item is inserted.

8. The method of claim 7, further comprising the step of:
(g) receiving said identifier and updating a corresponding data entry, in said memory, to indicate that said recyclable item is currently housed in said recycling receptacle.

9. The method of 8, further comprising the step of:
(h) receiving location information of said device and cross-checking said location information of said device with location information relating to said recycling receptacle, stored in said memory, so as to only allow said crediting if a location of said device coincides with a location of said recycling receptacle.

10. The method of 8, further comprising the step of:
(h) calculating an estimated capacity level of said recycling receptacle based on a number of recyclable items housed therein.

11. A system, comprising;
at least one processor;
at least one non-transitory computer readable medium storing a database including a data entry corresponding to a unique indicia for a recyclable item, said non-transitory computer readable medium storing instructions executable by the system, using the at least one processor to implement
computer code for receiving, at said processor, an electronic indication that said unique indicia has been scanned;
computer code for receiving, at said processor, a user ID related to a device that scanned said unique indicia;
computer code for associating said recyclable item with a value and crediting a user account belonging to said user ID with said value; and
computer code for updating said database to indicate that said unique indicia has been scanned, thereby preventing subsequent remuneration for scanning said unique indicia.
